(19) United States
(12) Patent Application Publication
(10) Pub. No.: US 2007/0089712 A1
(43) Pub. Date: Apr. 26, 2007

(54) Injector for fuel injection system and fuel injection system having such an injector

(75) Inventor: Fritz W. Spinnler, Mellingen (CH)

Correspondence Address: THE WEBB LAW FIRM, P.C., 700 KOPPERS BUILDING, 436 SEVENTH AVENUE, PITTSBURGH, PA, 15219, US

(73) Assignee: CRT COMMON RAIL TECHNOLOGIES AG, Neuhausen am Rheinfall (CH)

(21) Appl. No.: 11/584,960

(22) Filed: Oct. 23, 2006

(30) Foreign Application Priority Data
Oct. 25, 2005 (CH) 01712/05

(51) Int. Cl. F02M 57/02

(52) U.S. Cl. 123/446

(57) ABSTRACT

An injector for a fuel injection system includes (a) an injector housing extending along an axis, wherein the injector housing surrounds an internal high-pressure space adapted to receive fuel under high pressure; (b) an injection valve situated at a lower end of the injector housing and connected to the high-pressure space; and (c) a nozzle needle running through the high-pressure space in an axial direction wherein the nozzle needle is configured to be hydraulically actuated by an actuating mechanism arranged at an upper end of the injector housing, wherein the actuating mechanism is configured to open or close the injection valve depending on the axial position thereof, wherein at least two separate high-pressure junctions are situated within the injector housing, wherein the high-pressure junctions are configured to provide external access to the high-pressure space, and wherein the high-pressure junctions are configured to be connected to a high-pressure line.

### TECHNICAL FIELD

The present invention relates to the field of internal combustion engines with fuel injection. It refers to an injector for a fuel injection system according to the precharacterizing clause of Claim 1 and to a fuel injection system having such an injector.

### Prior Art

In fuel injection systems on the common-rail principle, normally the fuel conveyed by a high-pressure pump is pumped into the accumulator volume of a common rail which extends along the row of injectors and from which individual branch lines to each of the individually activated injectors emanate. Such an arrangement with a separate common rail has various disadvantages: the separate common rail, which has to be designed for the high fuel pressures, requires considerable outlay in production terms. This also applies particularly to the screw connections and junctions of the branch lines to the injectors, and to the supply and return lines to and from the high-pressure pump. Each of these junctions constitutes a risk in terms of leak-tightness. Furthermore, the common rail occupies a considerable space in the engine compartment in which increasingly more additional assemblies have to be accommodated.

It has already been proposed in EP-A1-1 469 188, within the framework of a coaxial double line which is provided for common-rail systems and in which the high-pressure supply line and low-pressure return line for the fuel are combined with one another, to equip the injectors of the common-rail system on the upper junction side with two combined high-pressure and low-pressure junctions lying opposite one another. The injectors can then be connected in series within the fuel injection system on the high-pressure and low-pressure side, the connecting lines between adjacent injectors, together with their high-pressure line volumes, forming the common rail.

Such a configuration is reproduced in diagrammatic form in FIG. 1, only two injectors 11 and 12 being illustrated. Each of the injectors 11, 12 has an internal high-pressure space 14 which issues downwards into an injection nozzle 13 which can be opened and closed by means of a nozzle needle 16. The high-pressure space 14 is connected in the manner of a T-piece, by means of a narrow connecting duct 15, to a line section of the high-pressure line 17. The said line section running between two high-pressure junctions A. The high-pressure line 17 forms the common rail and determines the accumulator volume of the latter. The high-pressure spaces 14 in the injectors 11, 12 are decoupled fluid-dynamically from the high-pressure line 17 by means of the narrow connecting ducts 15, so that the said high-pressure spaces do not play any part in the functioning of the common rail. In order to obtain a sufficient accumulator volume, therefore, the high-pressure line 17 has to be designed correspondingly. At the same time, the accumulator volume varies considerably with the distance of the injectors from one another.

### PRESENTATION OF THE INVENTION

The object of the invention, therefore, is to provide an injector for a fuel injection system on the common-rail principle, which makes it possible to simplify the injection system, without having the disadvantages of known solutions, and also to specify a fuel injection system operating with such injectors.

The object is achieved by means of the entirety of the features of Claims 1 and 9. The injector according to the invention is distinguished in that, in the injector housing, at least two separate high-pressure junctions are provided, which allow access from outside to the high-pressure space and which are designed in each case for the junction of a high-pressure line. In the fuel injection system according to the invention, the injectors are arranged with their high-pressure junctions in series in the high-pressure line in such a way that the high-pressure line leads through the high-pressure space of each injector.

A refinement of the injector according to the invention is characterized in that the high-pressure junctions are arranged at the upper end of the high-pressure space, and in that the high-pressure junctions are arranged at the same height in the axial direction. This results in good accessibility and in a simplification in terms of production and junction. This applies particularly when, according to a development, two high-pressure junctions are provided, and the two high-pressure junctions are arranged opposite one another with respect to the axis and are in alignment with one another.

A further simplification arises when the high-pressure junctions are identical to one another in configuration and dimensions, particularly in terms of the passage cross section.

The high-pressure junctions preferably have a thread for the releasable screwing-on of the high-pressure line, in particular the thread being designed as an internal thread.

The injector becomes particularly simple when the high-pressure space is arranged coaxially with respect to the axis of the injector.

The essential idea of the fuel injection system according to the invention is to use injectors having a high-pressure space, out of which the fuel required for injection is extracted, the volume of the high-pressure space being selected such that the sum of the volumes of the high-pressure spaces of the plurality of identical injectors in a common-rail injection system is sufficient to form the accumulator volume necessary for the common rail, and to insert these injectors with their high-pressure spaces one behind the other into the high-pressure line, so that the high-pressure spaces, together with the high-pressure line connecting them, form a common rail with a corresponding accumulator volume. A space-saving fuel injection system on the common-rail principle can thereby be implemented in a particularly simple and effective way.

The injectors according to the invention may advantageously be used for the fuel injection system.

A refinement of the fuel injection system according to the invention is characterized in that a return line is led back from the last of the injectors lying in series to the high-pressure pump. A type of ring line is thereby formed, which is advantageous for the compensation of pressure fluctuations in the accumulator volume formed.

### BRIEF EXPLANATION OF THE FIGURES

The invention will be explained in more detail below by means of exemplary embodiments, in conjunction with the drawing in which:

FIG. 1 shows a diagrammatic illustration of injectors arranged along a high-pressure line, with two high-pressure junctions, according to the prior art;

FIG. 2 shows an illustration, comparable to FIG. 1, of the principle of the fuel injection system according to the invention;

FIG. 3 shows a longitudinal section through a preferred exemplary embodiment of an injector according to the invention with a large-volume high-pressure space which is accessible from outside through two separate high-pressure junctions; and

FIG. 4 shows an exemplary embodiment of a fuel injection system according to the invention with injectors according to FIG. 2 lying in series and connected to one another by means of high-pressure connecting lines and with a return line to the high-pressure pump.

### WAYS OF IMPLEMENTING THE INVENTION

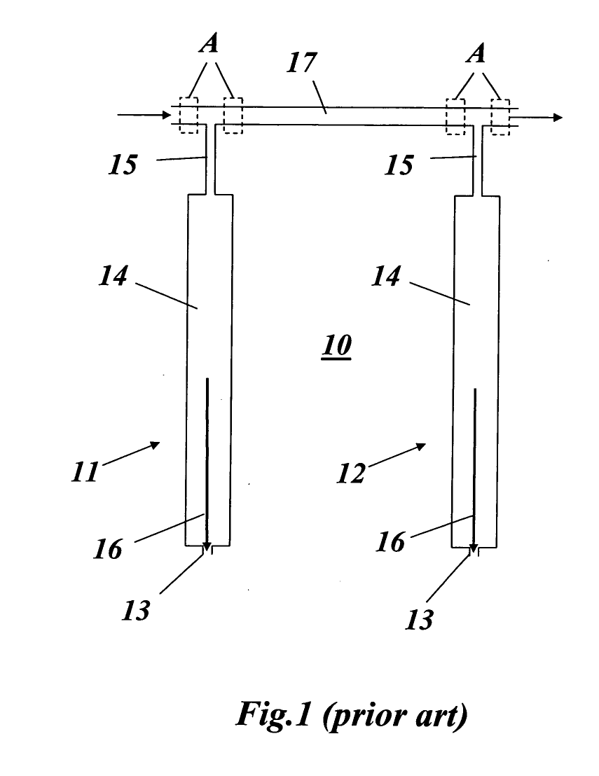

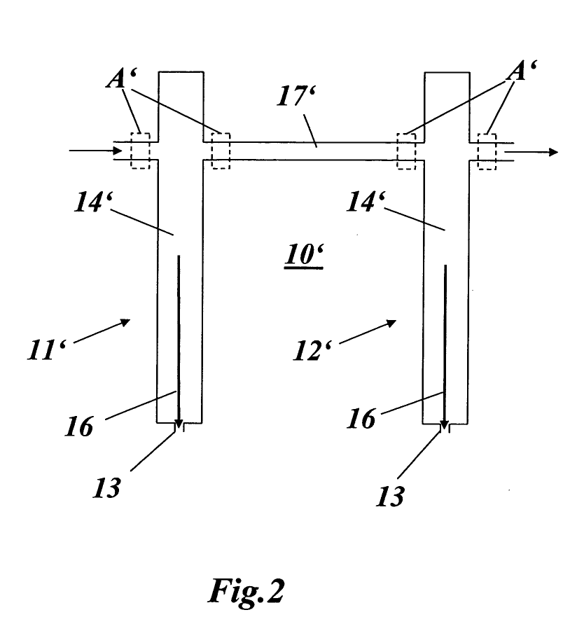

FIG. 2 reproduces the principle of the fuel injection system according to the invention in an illustration comparable to FIG. 1. Here, too, once again, of the fuel injection system 10′, only two injectors 11′ and 12′ of a plurality of injectors are shown. Each of the injectors 11′, 12′ has an internal high-pressure space 14′, out of which fuel which is under high pressure is injected through the injection valve, formed from the injection nozzle 13 and nozzle needle 16, into the combustion space. Arranged in each case on the high-pressure spaces 14′ of the injectors 11′, 12′ laterally and opposite one another are two high-pressure junctions A′, by means of which the injectors 11′, 12′ can be inserted in series into the high-pressure line 17′ coming from the high-pressure pump, such that the high-pressure spaces 14′ and that portion of the high-pressure line which connects them form a continuous accumulator volume in the manner of a common rail. The precondition for this is that the volume of the individual high-pressure space 14′ is large enough to ensure that the sum of the volumes of all the injectors lying in series is sufficient as a common-rail accumulator volume.

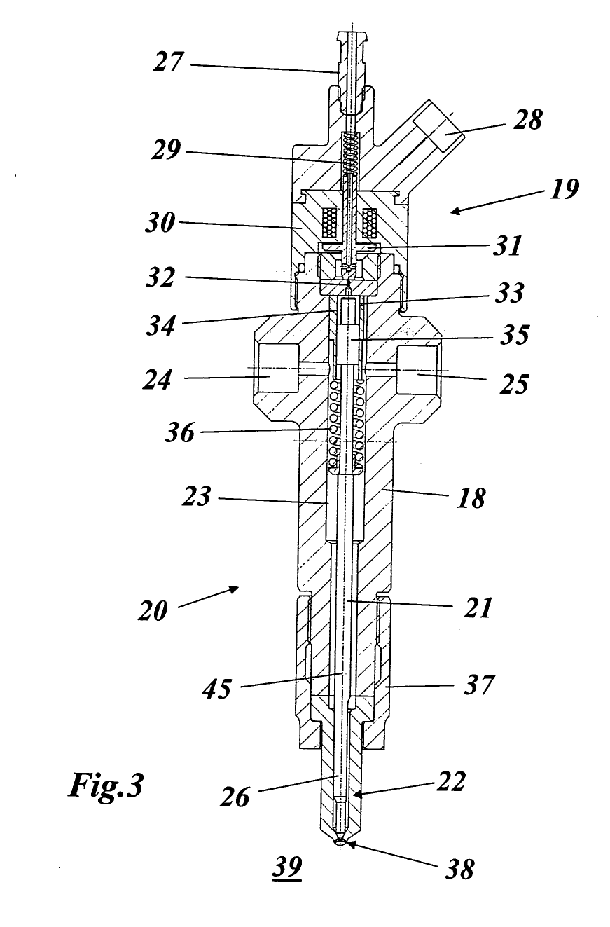

So that these requirements can be fulfilled, a novel injector is proposed. A preferred exemplary embodiment of such an injector according to the invention is reproduced in a longitudinal section in FIG. 3. The injector 20 is provided for the direct injection of fuel, preferably for diesel engines, based on the common-rail principle.

The injector 20 has, within an injector housing 18, a coaxial high-pressure space 23 which runs in the longitudinal direction (along the axis 45) and in which, for example, the nozzle needle 26 of the injector 20 is located. The actual injection valve 22 is screwed to the lower end of the injector housing 18 by means of a union nut 37. At the lower end of the injector valve 22 are located injection holes 38 which are connected to the high-pressure space 23 and can be opened or closed by means of the nozzle needle 26. Such an arrangement of the nozzle needle 26 with its needle shank 21 is particularly advantageous for the invention, because this high-pressure space 23 has a markedly larger volume, as compared with conventional injectors. Thus, in a standard common-rail injector, such as is shown, for example, in EP-A1-584 815, a bore carrying high pressure runs approximately parallel to the nozzle. However, this thin bore has an insignificant volume, and therefore an injector designed in this way can scarcely come under consideration for forming a common rail. By contrast, low pressure prevails in the space, surrounding the nozzle-needle shank, of the conventional injector.

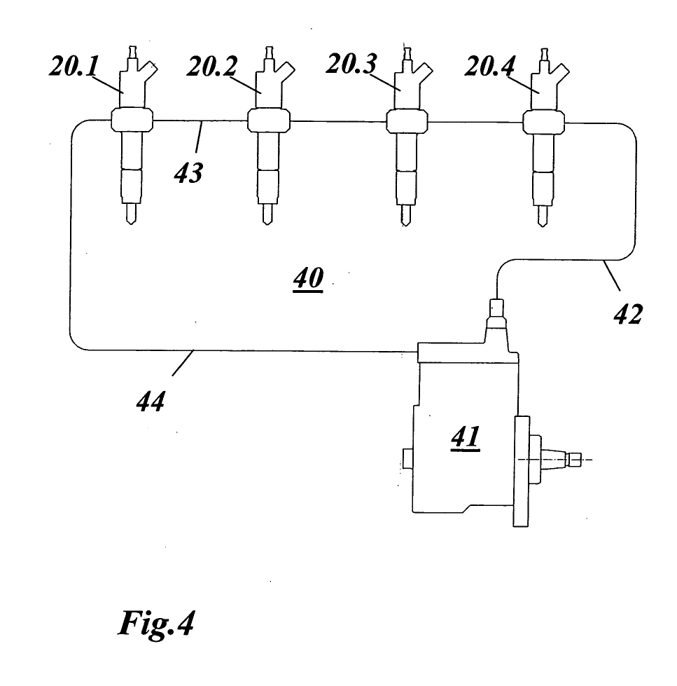

As already stated further above, at the centre of the invention, there is the idea of omitting the common rail which forms the accumulator volume in common-rail systems corresponding to the prior art. This is replaced by the sum of the individual volumes of the high-pressure spaces 23 in the injectors, in that these are connected to one another in the manner of a series connection via simple high-pressure lines (FIG. 4).

For this purpose, the high-pressure space 23 of the injector 20 must have at least two separate high-pressure junctions 24 and 25 (FIG. 3). These high-pressure junctions 24, 25 are attached to the injector housing 18 so as to project laterally in the radial direction and in each case issue into the high-pressure space 23 and thus provide a connection of the high-pressure space 23 to the high-pressure connecting lines (43 in FIG. 4) which connect the series-connected injectors 20.1, . . . , 20.4 to one another (FIG. 4). The high-pressure pump 41 likewise has two high-pressure junctions and, together with the high-pressure supply line 42, the injectors 20.1, . . . , 20.4, the high-pressure connecting lines 43 and the return line 44, forms a kind of ring line, this being advantageous for the compensation of pressure fluctuations in the accumulator volume formed.

The high-pressure junctions 24, 25 on the injector housing 18 are arranged preferably at the same height in the axial direction. They are arranged opposite one another with respect to the axis 45 and are in alignment with one another. Furthermore, they are identical to one another in configuration and dimensions, particularly in the terms of the passage cross section. The high-pressure junctions 24, 25 have, for example, an internal thread (not depicted in FIG. 3) which is designed as a counterthread for a high-pressure screw connection (not illustrated) for the pressure-resistant connection to the high-pressure line 42, 43, 44 (FIG. 4). The connection points on the high-pressure pump 41 (FIG. 4) are similarly designed.

The injector 20 illustrated in FIG. 3 has, in detail, the following construction:

An actuating mechanism 19 for controlling the injection valve 22 is illustrated diagrammatically on top of the injector 20. The actuating mechanism 19 has, for example, an electromagnet 30 which attracts an associated armature 31 when acted upon by an exciting pulse fed in via the junction 28 and which thereby releases a control bore 32 (the electromagnet 30 itself is connected fixedly to the injector housing 18). By the control bore 32 being opened, the pressure in a control space 34 arranged beneath it falls. A control piston 35 moveable slidingly in the axial direction in the control space 34 and the needle shank 21 adjoining the said control piston are lifted, together with the nozzle needle 26, counter to the pressure of a closing spring 36, the injection holes 38 arranged at the lower tip of the injection valve 22 are released, and the fuel is injected out of the high-pressure space 23 into the combustion space 39 surrounding the tip of the injection valve 22.

When the excitation of the electromagnet 30 is interrupted, the spring 29 presses the armature 31 downwards and the control bore 32 is closed. Fuel continues to flow through the smaller bore 33 leading to the control space 34 into the control space 34. The pressure difference acting on the control piston 35 is cancelled due to the fact that the closing spring 36 presses the needle shank 21 together with the nozzle needle 26 downwards, and the injection through the injection holes 38 is interrupted.

The fuel quantity flowing out while the control bore 32 is open (with the electromagnet 30 excited) flows through the hollow armature 31 upwards through a return nipple 27 via a collecting hose, not illustrated, back into the fuel tank (likewise not illustrated).

An exemplary fuel injection system 40 according to the invention for four cylinders is illustrated in simplified form in FIG. 4. A high-pressure supply line 42 leads from a high-pressure pump 41 for the fuel to the four injectors 20.1 to 20.4 lying in series and connected to one another by means of high-pressure connecting lines 43. A return line 44 leads from the last injector 20.1 of the row of four injectors back to the high-pressure pump 41. The injectors 20.1 to 20.4 preferably have the internal construction, such as is illustrated in FIG. 3 by means of the injector 20. They are inserted with their high-pressure spaces 23 directly into the ring line formed from the lines 42, 43 and 44. The sum of the volumes of the four high-pressure spaces 23 and of the interposed high-pressure connecting lines 43 forms, in the manner of a common rail, an accumulator volume for the fuel which is under high pressure, which accumulator volume can replace in full the conventional external common rail. It will be appreciated that the principle of the invention may be employed not only for four cylinders, but similarly also for other numbers of cylinders, such as, for example, 3, 5, 6 or 8.

### LIST OF REFERENCE SYMBOLS

10, 10′,40 Fuel injection system
11, 11′, 12, 12′ Injector
13 Injection nozzle
14, 14′ High-pressure space
15 Connecting duct
16 Nozzle needle
17, 17′ High-pressure line
18 Injector housing
19 Actuating mechanism
20 Injector
20.1, . . . , 20.4 Injector
21 Needle shank
22 Injection valve
23 High-pressure space
24, 25 High-pressure junction
26 Nozzle needle
27 Return nipple
28 Junction (electromagnet)
29 Spring
30 Electromagnet
31 Armature
32 Control bore
33 Bore (small)
34 Control space
35 Control piston
36 Closing spring
37 Union nut
38 Injection hole
39 Combustion space
41 High-pressure pump
42 High-pressure supply line
43 High-pressure connecting line
44 Return line
45 Axis
A,A′ High-pressure junction

1-11. (canceled)

12. An injector for a fuel injection system, comprising:
an injector housing extending along an axis, wherein the injector housing surrounds an internal high-pressure space adapted to receive fuel under high pressure;
an injection valve situated at a lower end of the injector housing and connected to the high-pressure space; and
a nozzle needle running through the high-pressure space in an axial direction wherein the nozzle needle is configured to be hydraulically actuated by an actuating mechanism arranged at an upper end of the injector housing, wherein the actuating mechanism is configured to open or close the injection valve depending on the axial position thereof, wherein at least two separate high-pressure junctions are situated within the injector housing, wherein the high-pressure junctions are configured to provide external access to the high-pressure space, and wherein the high-pressure junctions are configured to be connected to a high-pressure line.

13. The injector according to claim 12, wherein the high-pressure junctions are arranged at an upper end of the high-pressure space.

14. The injector according to claim 13, wherein the high-pressure junctions are arranged at a same height with respect to each other in the axial direction.

15. The injector according to claim 12, wherein the two high-pressure junctions are arranged opposite one another with respect to the axis and are in alignment with one another.

16. The injector according to claim 12, wherein the high-pressure junctions are substantially similar to one another with respect to their configuration and dimensions.

17. The injector according to claim 12, wherein the high-pressure junctions have a thread for releasably screwing the high-pressure line thereon.

18. The injector according to claim 17, wherein the thread is an internal thread.

19. The injector according to claim 12, wherein the high-pressure space is arranged coaxially with respect to the axis of the injector.

20. A fuel injection system having a high-pressure pump and a plurality of injectors, wherein each of the injectors are supplied by the high-pressure pump via a high-pressure line with fuel under high pressure, wherein each of the injectors include a high-pressure space from where the fuel required for injection is extracted, wherein the volume of the high-pressure space is selected such that the sum of the volumes of the high-pressure spaces of a plurality of substantially similar injectors in a common-rail injection system is sufficient for forming an accumulator volume required for the common rail, and wherein each of the injectors is arranged one behind the other and is connected to the high-pressure line.

21. The fuel injection system according to claim 20, wherein each injector comprises:
an injector housing extending along an axis, wherein the injector housing surrounds the internal high-pressure space adapted to receive the fuel under high pressure;
an injection valve situated at a lower end of the injector housing and connected to the high-pressure space; and
a nozzle needle running through the high-pressure space in an axial direction wherein the nozzle needle is configured to be hydraulically actuated by an actuating mechanism arranged at an upper end of the injector housing, wherein the actuating mechanism is configured to open or close the injection valve depending on the axial position thereof, wherein at least two separate high-pressure junctions are situated within the injector housing, wherein the high-pressure junctions are configured to provide external access to the high-pressure space, and wherein the high pressure junctions are configured to be connected to the high-pressure line.

22. The fuel injection system according to claim 20, wherein a return line is led from the last of the injectors lying in series back to the high-pressure pump.

23. The fuel injection system according to claim 20, wherein each of the injectors is connected to the high-pressure line by insertion of each of the injectors therein.
